(19) United States
(12) Patent Application Publication
(10) Pub. No.: US 2013/0019281 A1
(43) Pub. Date: Jan. 17, 2013

(54) Server Based Remote Authentication for BIOS

(71) Applicants: William E. Jacobs, Beaverton, OR (US); Sunil Bhagia, Olympia, WA (US); Dmitry Barsky, San Jose, CA (US)

(72) Inventors: William E. Jacobs, Beaverton, OR (US); Sunil Bhagia, Olympia, WA (US); Dmitry Barsky, San Jose, CA (US)

(73) Assignee: CISCO TECHNOLOGY, INC., San Jose, CA (US)

(21) Appl. No.: 13/179,746

(22) Filed: Jul. 11, 2011

(51) Int. Cl. G06F 21/20

(52) U.S. Cl. 726/4

(57) ABSTRACT

Techniques are provided for authenticating a user when accessing a Basic Input/Output System (BIOS) of a computing device. Access request information is received. An access information database is queried to authenticate the access request information with access information stored in the access information database. Validation information is received, indicating whether the access request information is authenticated, and permission is granted for access to settings of the computing device if the validation information indicates that the access request information is authenticated.

### TECHNICAL FIELD

The present disclosure relates to authentication and access rights to a computing device.

### BACKGROUND

Users can log into a Basic Input/Output System (BIOS) of a computing device by authenticating with the BIOS. Typically, this authentication is password protected, and it is not usually tied to other user or client authentication schemes. However, because the BIOS password is not tied to other global passwords or authentication schemes, the server administrator has to remember several passwords and authentication schemes in order to deal with each server individually. This is inconvenient since a user needs to manage multiple passwords for different authentication schemes. Having a local password that is not tied to other managed server-array password schemes also means a local user could access the individual server locally, and set a password that the remote server management application is not aware of, thus rendering the server inaccessible by the server management application. Additionally, because the authentication to the BIOS is not tied to the other authentication schemes, a server hosted on the computing device does not have access to the BIOS, and thus, the server cannot operate with a stateless server management protocol. Moreover, in a large installation, local password protection with the computing device faces security risks for unauthorized access to the BIOS of the computing device. Such a server becomes un-configurable and un-manageable in a managed array of servers, as is commonly deployed in data centers.

### BRIEF DESCRIPTION OF THE DRAWINGS

FIG. 1 shows an example network topology that supports user authentication with a Basic Input/Output System (BIOS) of a computing device.

FIG. 2 is an example block diagram of a computing device with BIOS authentication and access logic to determine access privileges for a user.

FIG. 3 is an example block diagram of a server manager device configured to manage the computing device and configured with access request authentication logic.

FIG. 4 is a flow chart depicting operations of the BIOS authentication and access logic executed in the computing device to authenticate a user.

FIG. 5 is a flow chart depicting operations of the access request authentication logic executed in the server manager device to authenticate access request information received from a user of the user.

### DESCRIPTION OF EXAMPLE EMBODIMENTS

Overview

Techniques are provided for authenticating a user when accessing a Basic Input/Output System (BIOS) of a computing device. Access request information is received at a management controller device in the computing device. An access information database is queried to authenticate the access request information with access information stored in the access information database. Validation information is received, indicating whether the access request information is authenticated, and permission is granted for access to settings of the computing device if the validation information indicates that the access request information is authenticated.

### Example Embodiments

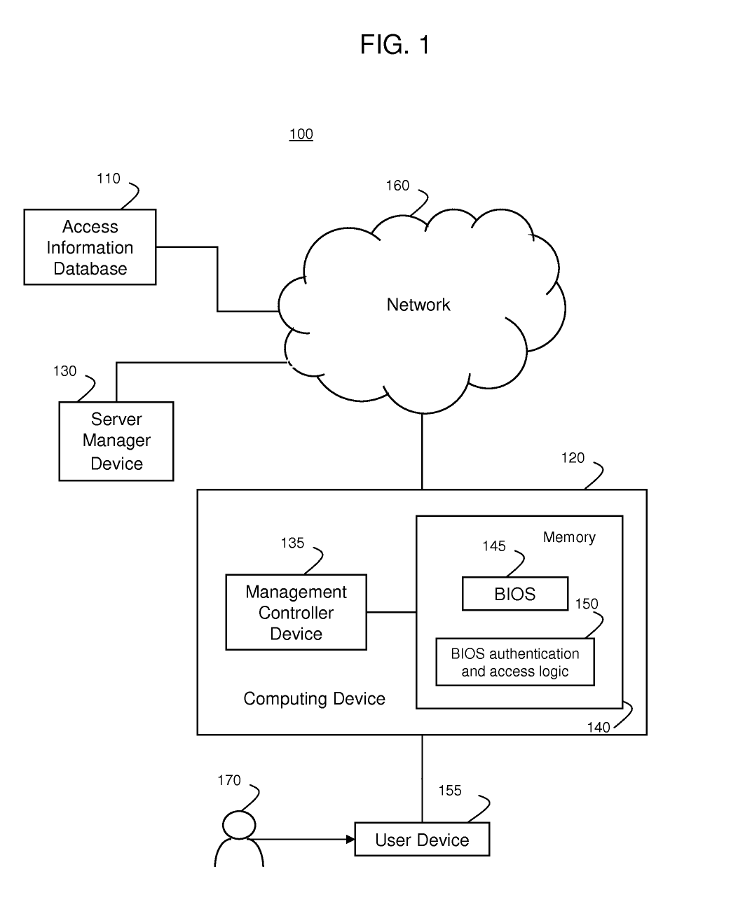

FIG. 1 shows an example of a network topology 100 that supports client authentication with a computing device. There is an access information database 110, a computing device 120 and a server manager device 130 (e.g., a server array manager device). Computing device 120 comprises a management controller device 135 and a memory 140. Memory 140 is configured to store, for example, instructions for a BIOS 145 and for BIOS authentication and access logic 150. The BIOS authentication and access logic 150 is configured to determine access privileges for a user device 155, as described herein. The user device 155 may be any device that allows a user to access or control components of the computing device 120, according to the techniques described herein. In one form, for example, user device 155 may be what is referred to as a management console device. In general, the user device 155 may be any computing device configured with input/output capabilities. Examples of user device 155 include, but are not limited to, laptop computers, desktop computers, mobile devices, smart phone devices, a thin client computing device, tablet computing devices, or any other computing device capable of interfacing with computing device 120.

Access information database 110, computing device 120 and server manager device 130 communicate with each other across a network 160. Network 160 may be any communication network, for example, a wired or wireless local area network (LAN), a wired or wireless wide area network (WAN), etc. In general, access information database 110 is configured to store authentication information (e.g., password information) associated with BIOS 145 of computing device 120. This authentication information can be used to authenticate users who seek to modify settings of BIOS 145, as described herein.

A user 170 of the user device 155 may attempt to access BIOS 145 of computing device 120 directly by communicating with the management controller device 135 of computing device 120. For example, as shown in FIG. 1, the user device 155 may be in direct communication with the computing device 120 to allow user 170 to access BIOS 145. User 170 of user device 155 may also attempt to access BIOS 145 indirectly by, for example, communicating first with server manager device 130, which, in turn, communicates with management controller device 135 of computing device 120, as described herein. For simplicity, FIG. 1 shows the user 170 and user device 155 only in direct communication with the computing device, though it should be understood that the user 170 may communicate with the computing device 120 via the user device 155 through the server manager device 130. The management controller device 135 is also known and referred to as a baseboard management controller (BMC). The management controller device 135 is configured to monitor BIOS settings and operations associated with BIOS 145. For example, management controller device 135 may monitor requests for access to BIOS 145. The management controller device 135 is also configured to monitor performance characteristics of computing device 120. For example, management controller device 135 monitors parameters of computing device 120, such as temperature, cooling fan speeds, power status, operating system functionality, etc. The management controller device 135 can modify the performance characteristics based on operating requirements associated with computing device 120.

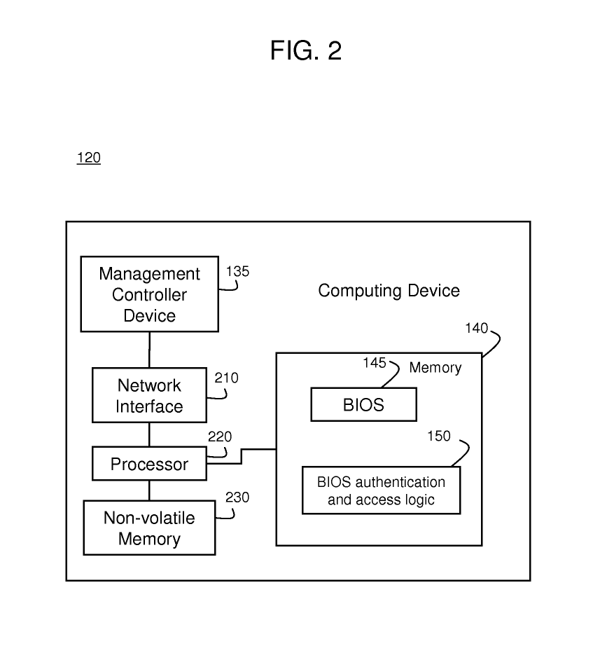

Turning to FIG. 2, an example block diagram of computing device 120 is now described. Computing device 120 is, for example, a server computer apparatus, and comprises management controller device 135 and memory 140, as described above. Memory 140 is configured to store instructions for BIOS 145 and instructions for BIOS authentication and access logic 150. Computing device 120 also comprises a network interface device 210, a processor 220, and a non-volatile memory 230. Processor 220 is coupled to management controller 135, memory 140, network interface device 210, and non-volatile memory 230. Processor 220 is a microprocessor or microcontroller that is configured to execute program logic instructions (i.e., software) for carrying out various operations and tasks described herein. For example, processor 220 is configured to execute BIOS authentication and access logic 150 that is stored in memory 140 to obtain authentication information associated with user 170 of user device 155 in order to grant user 170 (e.g., through user device 155) access to BIOS 145. For example, processor 220 may grant user device access to BIOS 145 so that user 170 is able to configure BIOS settings associated with BIOS 145. Memory 140 may comprise read only memory (ROM), random access memory (RAM), magnetic disk storage media devices, optical storage media devices, flash memory devices, electrical, optical or other physical/tangible memory storage devices. Non-volatile memory 230 is, for example, non-volatile random access memory (NVRAM).

The functions of processor 220 may be implemented by logic encoded in one or more tangible computer readable storage media (e.g., embedded logic such as an application specific integrated circuit, digital signal processor instructions, software that is executed by a processor, etc), wherein memory 140 stores data used for the operations described herein and stores software or processor executable instructions that are executed to carry out the operations described herein.

BIOS authentication and access logic 150 may take any of a variety of forms, so as to be encoded in one or more tangible computer readable memory media or storage device for execution, such as fixed logic or programmable logic (e.g., software/computer instructions executed by a processor) and the processor 220 may be an application specific integrated circuit (ASIC) that comprises fixed digital logic, or a combination thereof. For example, the processor 220 may be embodied by digital logic gates in a fixed or programmable digital logic integrated circuit, which digital logic gates are configured to perform BIOS authentication and access logic 150. In general, BIOS authentication and access logic 150 may be embodied in one or more computer readable storage media encoded with software comprising computer executable instructions and when the software is executed operable to perform the operations described herein for logic 150.

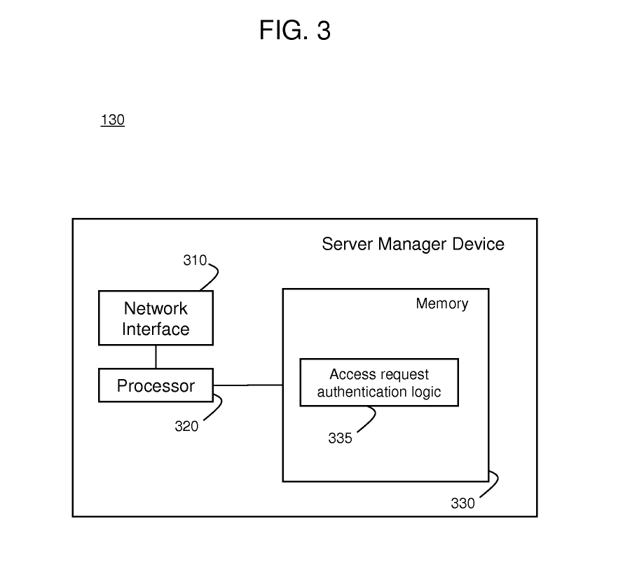

Reference is now made to FIG. 3. FIG. 3 shows an example block diagram of server manager device 130. Server manager device 130 comprises a network interface device 310, a processor 320 and a memory 330. Memory 330 is configured to store access request authentication logic 335. Memory 330 may comprise ROM, RAM, magnetic disk storage media devices, optical storage media devices, flash memory devices, electrical, optical or other physical/tangible memory storage devices.

The functions of processor 320 may be implemented by logic encoded in one or more tangible computer readable storage media (e.g., embedded logic such as an application specific integrated circuit, digital signal processor instructions, software that is executed by a processor, etc), wherein memory 330 stores data used for the operations described herein and stores software or processor executable instructions that are executed to carry out the operations described herein.

Access request authentication logic 335 may take any of a variety of forms, so as to be encoded in one or more tangible computer readable memory media or storage device for execution, such as fixed logic or programmable logic (e.g., software/computer instructions executed by a processor) and the processor 320 may be an ASIC that comprises fixed digital logic, or a combination thereof. For example, the processor 320 may be embodied by digital logic gates in a fixed or programmable digital logic integrated circuit, which digital logic gates are configured to perform access authentication logic 335. In general, access authentication logic 335 may be embodied in one or more computer readable storage media encoded with software comprising computer executable instructions and when the software is executed operable to perform the operations described herein for logic 335.

In general, server manager device 130 can send access requests directly to the computing device 120. In one example, server manager device 130 sends requests directly to non-volatile memory 230 of computing device 120 in order to update BIOS settings. However, BIOS 145 may be password protected, and accordingly, requests to update BIOS settings would not reach non-volatile memory 230 without first being authenticated. Similarly, credentials of user 170 associated with the user device 155 (e.g., passwords entered by user 170) may need to be authenticated in order to grant access to the user device 155 for user 170 to update BIOS settings. In one embodiment, access information (e.g., one or more passwords) associated with BIOS 145 may be stored remotely, for example, in database 110. In this example, management controller 135 can manage BIOS setup and authentication from a secure database such as one on a lightweight directory access protocol (LDAP) server. Using a secure interface to the access information associated with BIOS 145, BIOS authentication and access logic 150 will authenticate against authentication information (e.g., passwords) associated with BIOS 145. Thus, BIOS set up changes sent from a remote server are ensured and can be applied permanently from a remote device, such as server manager device 130 or the user device 155.

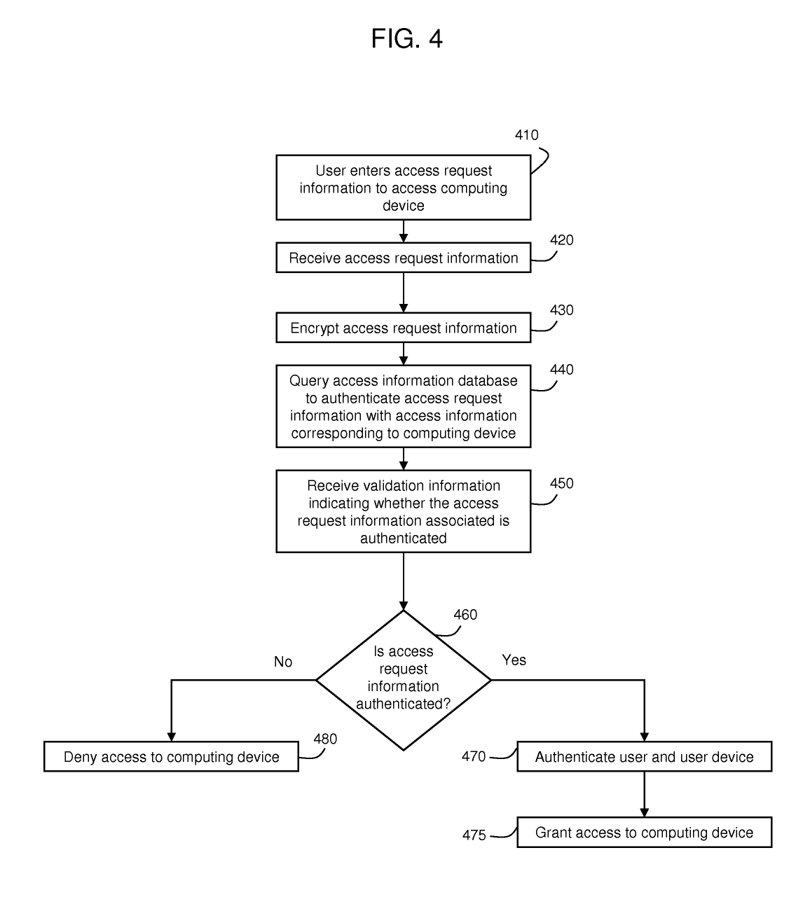

In one example, as user 170 (through the user device 155) requests to access BIOS 145 (for example, by entering a user password) directly or indirectly, as stated above, BIOS authentication and access logic 150 authenticates user 170 and the user device 155 to determine whether to grant user 170 access to the BIOS settings of BIOS 145. This technique is described hereinafter in connection with FIG. 4.

FIG. 4 shows a flow chart depicting operations of BIOS authentication and access logic 150 to determine access privileges for user 170 at the user device 155. At 410, user 170, through the user device 155, enters access request information to access computing device 120 (e.g., BIOS 145 of computing device 120). For example, user 170 may enter a password at the user device 155 that is in direct communication with computing device 120 over network 160 in order to access BIOS settings. After user 170 enters the access request information, at 420, management controller device 135 of computing device 120 receives the access request information entered by user 170. At 430, management controller device 135 encrypts the access request information, and at 440, queries access information database 110 to authenticate the access request information with access information (e.g., BIOS access passwords) stored in access information database 110. Management controller device 135 may query access information database 110 directly, or it may query server manager device 130, which, in turn, sends the query to the access information database 110. In the example where the management controller device 135 queries the server manager 130, the server manager device 130, upon receiving the query, may decrypt the access request information entered by user 170, determine whether the access request information corresponds to access information stored in the access information database 110 and generate validation information indicating whether the access request information is authenticated (i.e., whether the access request information is found in the access information database 110).

At 450, management controller device 135 of computing device 120 receives validation information indicating whether the access request information associated with user 170 and the user device 155 is authenticated. Management controller device 135 may receive this validation directly from access information database 110 or may receive this validation from server manager device 130. At 460, management controller device 135 determines whether the access request information is authenticated, for example, based on the validation received in 450. If the access request information is authenticated, the management controller device 135, at 470, authenticates user 170 and user device 155 and, at 475, grants access to settings of the computing device 120. If the access request information is not authenticated, the management controller device 135, at 480 denies access to the computing device 120.

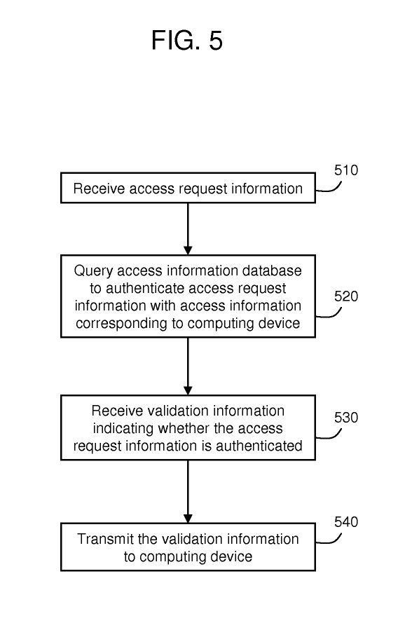

In another embodiment of the techniques described herein, a user 170 (through user device 155) may request to access BIOS 145 through server manager device 130. In this example, access request authentication logic 335 stored in memory 330 of server manager 130 can authenticate user 170 and user device 155 to determine whether user 170 and the user device 155 should be granted access to BIOS 145. This technique is now described with reference to the flow chart in FIG. 5.

At 510, server manager device 130 receives access request information (e.g., a password) from user 170 of the user device 155. As explained above, the access request information from user 170 of the user device 155 may be a request to access BIOS 145 of computing device 120. Server manager device 130 may receive the access request information directly from user 170 (through the user device 155) or may receive the access request information from computing device 120 (for example, from management controller device 135). Upon receiving the access request information, server manager device 130, at 520, queries an access information database 110 to authenticate the access request information with access information stored in access information database 110. Server manager device 130 queries access information database in order to determine whether the user device 155 is permitted to access the computing device 120. After querying access information database 110, server manager device 130, at 530, receives validation information indicating whether the access request information is authenticated. Alternatively, server manager device 130 may generate such validation information after receiving confirmation as to whether or not the access request information is authenticated (i.e., whether the access request information matches access information associated with computing device 120). At 540, server manager device 130 transmits the validation information to management controller device 135 in the computing device 120 to grant access to the user device 155 to allow user 170 to access computing device 120 if the validation information indicates that the access request information of user 170 is authenticated. In one example, server manager device 130 may encrypt the validation information before transmitting the validation information to management controller device 135. Upon receiving the encrypted validation information, the management controller device 135 can grant access to settings of the compute device 120 based on whether the access request information is authenticated (as explained above in connection with operation 460 in FIG. 4). Thus, by querying access information database 110 and transmitting validation information to computing device 120, an authenticated user can access computing device 120 to modify or access settings associated with BIOS 145.

It should be appreciated that the techniques described herein may be performed by one or more computer readable storage media that is encoded with software comprising computer executable instructions to perform the methods and steps described herein.

In summary, a method is provided comprising: at a management controller device in a computing device, receiving access request information to access the computing device; querying an access information database to authenticate the access request information with access information stored in the access information database; receiving validation information indicating whether the access request information is authenticated; and granting permission for access to settings of the computing device if the validation information indicates that the access request information is authenticated.

In addition, a method is provided comprising: at a server manager device, receiving access request information to access a computing device over a network; querying an access information database to authenticate the access request information with access information stored in the access information database; receiving validation information indicating whether the access request information; and if the validation information indicates that the access request information is authenticated, transmitting the validation information to a management controller device in the computing device to grant permission to access settings of the computing device.

Furthermore, one or more computer readable storage media encoded with software comprising computer executable instructions and when the software is executed operable to: receive access request information to access a computing device; query an access information database to authenticate the access request information with access information stored in the access information database; receive validation information indicating whether the access request information is authenticated; and grant permission for access to settings of the computing device if the validation information indicates that the access request information is authenticated.

Additionally, one or more computer readable storage media encoded with software comprising computer executable instructions and when the software is executed operable to: receive access request information to access a computing device over a network; query an access information database to authenticate the access request information with access information stored in the access information database; receive validation information indicating whether the access request information; and if the validation information indicates that the access request information is authenticated, transmit the validation information to a management controller device in the computing device to grant permission to access settings of the computing device.

Furthermore, an apparatus is provided comprising: a network interface device configured to enable communications over a network; a management controller device configured to monitor access requests to modify settings associated with the apparatus; and a processor configured to: receive access request information; query an access information database to authenticate the access request information with access information stored in the access information database; receive validation information indicating whether the access request information is authenticated; and grant permission for access to settings controlled by the management controller device if the validation information indicates that the access request information is authenticated.

In addition, an apparatus is provided comprising: a network interface device configured to enable communications over a network; and a processor configured to: receive access request information to access a computing device over a network; query an access information database to authenticate the access request information with access information stored in the access information database; receive validation information indicating whether the access request information is authenticated; and if the validation information indicates that the access request information is authenticated, transmit the validation information to the management controller device in the computing device to grant permission for access to settings of the computing device.

The above description is intended by way of example only. Various modifications and structural changes may be made therein without departing from the scope of the concepts described herein and within the scope and range of equivalents of the claims.

What is claimed is:

1. A method comprising:
at a management controller device in a computing device, receiving access request information to access the computing device;
querying an access information database to authenticate the access request information with access information stored in the access information database;
receiving validation information indicating whether the access request information of the access request is authenticated; and
granting permission for access to settings of the computing device if the validation information indicates that the access request information is authenticated.

2. The method of claim 1, wherein granting permission comprises granting access to a Basic Input/Output System (BIOS) in the computing device.

3. The method of claim 1, wherein querying comprises sending a query to a server manager device, which in turn, sends the query to the access information database.

4. The method of claim 3, further comprising:
at the server manager device, receiving the query to determine whether the access request is permitted;
authenticating the access request information by determining whether the access request information corresponds to access information stored in the access information database;
generating validation information indicating whether the access request information is authenticated; and
transmitting the validation information to the management controller device.

5. The method of claim 4, further comprising encrypting the validation information before transmitting the validation information to the management controller device.

6. The method of claim 1, wherein querying comprises sending a query directly to the access information database.

7. A method comprising:
at a server manager device, receiving access request information to access a computing device over a network;
querying an access information database to authenticate the access request information with access information stored in the access information database;
receiving validation information indicating whether the access request information is authenticated; and
if the validation information indicates that the access request information is authenticated, transmitting the validation information to a management controller device in the computing device to grant permission to access settings of the computing device.

8. The method of claim 7, wherein receiving comprises receiving the access request information to access a Basic Input/Output System (BIOS) of the management controller device.

9. The method of claim 7, further comprising decrypting the access request information at the access information database.

10. The method of claim 7, further comprising encrypting the validation information before transmitting the validation information to the management controller device.

11. One or more computer readable storage media encoded with software comprising computer executable instructions and when the software is executed operable to:
receive access request information to access a computing device;
query an access information database to authenticate the access request information with access information stored in the access information database;
receive validation information indicating whether the access request information is authenticated; and
grant permission for access to settings of the computing device if the validation information indicates that the access request information is authenticated.

12. The computer readable storage media of claim 11, wherein the instructions operable to grant access comprise instructions operable to grant access to a Basic Input/Output System (BIOS) of the computing device.

13. The computer readable storage media of claim 11, wherein the instructions operable to query comprise instructions operable to send a query to a server manager device to determine whether the access request is permitted.

14. One or more computer readable storage media encoded with software comprising computer executable instructions and when the software is executed operable to:
receive access request information to access a computing device over a network;
query an access information database to authenticate the access request information with access information stored in the access information database;
receive validation information indicating whether the access request information is authenticated; and
if the validation information indicates that the access request information is authenticated, transmit the validation information to a management controller device in the computing device to grant permission to access settings of the computing device.

15. The computer readable storage media of claim 14, wherein the instructions operable to receive comprise instructions operable to receive access request information to access a Basic Input/Output System (BIOS) of the computing device.

16. The computer readable storage media of claim 14, further comprising instructions operable to decrypt the access request information at the access information database.

17. The computer readable storage media of claim 14, further comprising instructions operable to encrypt the validation information before transmitting the validation information to the management controller device.

18. An apparatus comprising:
a network interface device configured to enable communications over a network;
a management controller device configured to monitor access requests to modify settings associated with the apparatus; and
a processor configured to:
receive access request information;
query an access information database to authenticate the access request information with access information stored in the access information database;
receive validation information indicating whether the access request information of the access request is authenticated; and
grant permission for access to settings controlled by the management controller device if the validation information indicates that the access request information is authenticated.

19. The apparatus of claim 18, wherein the processor is further configured to grant access to a Basic Input/Output System (BIOS).

20. An apparatus comprising:
a network interface device configured to enable communications over a network; and
a processor configured to:
receive access request information to access a computing device over the network;
query an access information database to authenticate the access request information with access information stored in the access information database;
receive validation information indicating whether the access request information is authenticated; and
if the validation information indicates that the access request information is authenticated, transmit the validation information to a management controller device in the computing device to grant permission to access settings of the computing device.

21. The apparatus of claim 20, wherein the processor is further configured to receive access request information to access a Basic Input/Output System (BIOS) of the computing device.
